(19) United States
(12) Patent Application Publication
(10) Pub. No.: US 2021/0031730 A1
(43) Pub. Date: Feb. 4, 2021

(54) CONTROL APPARATUS, VEHICLE, AND CONTROL METHOD

(71) Applicant: TOYOTA JIDOSHA KABUSHIKI KAISHA, Toyota-shi (JP)

(72) Inventors: Keiko NAKANO, Kawasaki-shi (JP); Yu NAGATA, Nagoya-shi (JP); Takashi HAYASHI, Aichi-gun (JP); Ryota KONDO, Nagoya-shi (JP)

(73) Assignee: TOYOTA JIDOSHA KABUSHIKI KAISHA, Toyota-shi (JP)

(21) Appl. No.: 16/945,450

(22) Filed: Jul. 31, 2020

(30) Foreign Application Priority Data
Jul. 31, 2019 (JP) 2019-141643

(51) Int. Cl. B60S 1/64; B60S 1/56; G06K 9/00

(52) U.S. Cl. CPC B60S 1/64; G06K 9/00832; B60S 1/56

(57) ABSTRACT

A control apparatus, a vehicle, and a control method which improve usability of a technique of determining a dirt level of a vehicle are provided. The control apparatus of the vehicle includes a controller. The controller determines whether it is necessary to clean the vehicle, based on at least one of first information indicating a dirt level of the vehicle detected by the vehicle, and second information indicating a dirt level of the vehicle input by a user of the vehicle.

### CROSS-REFERENCE TO RELATED APPLICATION

The present application claims priority to Japanese Patent Application No. 2019-141643 filed on Jul. 31, 2019, the entire disclosure of which is incorporated herein by reference.

### TECHNICAL FIELD

The present disclosure relates to a control apparatus, a vehicle, and a control method.

### BACKGROUND

Conventionally, techniques for determining a dirt level of a vehicle are known. For example, JP 2017-137010 A (PTL 1) discloses an odor monitoring system which detects the amount of a volatile organic compound in the air blown from an outlet of an air conditioning apparatus provided in a vehicle, and displays a detection result.

### CITATION LIST

### Patent Literature

PTL 1: JP 2017-137010 A

### SUMMARY

In recent years, it is desired to further improve the usability of techniques for determining a dirt level of a vehicle. For example, it is desired to determine whether it is necessary to clean a vehicle, based on information indicating the dirt level of the vehicle.

An object of the present disclosure which has been made in view of such circumstances is to provide a control apparatus, a vehicle, and a control method which improve the usability of a techniques for determining a dirt level of a vehicle.

A control apparatus according to an embodiment of the present disclosure is a control apparatus for a vehicle, which includes a controller configured to determine whether it is necessary to clean the vehicle, based on at least one of first information indicating a dirt level of the vehicle detected by the vehicle, and second information indicating a dirt level of the vehicle input by a user of the vehicle.

A control method according to an embodiment of the present disclosure is a control method for a vehicle. In the control method, a controller determines whether it is necessary to clean the vehicle, based on at least one of first information indicating a dirt level of the vehicle detected by the vehicle, and second information indicating a dirt level of the vehicle input by a user of the vehicle.

According to the control apparatus, the vehicle, and the control method according to an embodiment of the present disclosure, the usability of techniques for determining a dirt level of a vehicle are improved.

### BRIEF DESCRIPTION OF THE DRAWINGS

In the accompanying drawings:

FIG. 1 is a schematic diagram illustrating the interior of a vehicle according to an embodiment of the present disclosure;

FIG. 2 is a block diagram illustrating a schematic configuration of the vehicle according to an embodiment of the present disclosure;

FIG. 3 is a flowchart illustrating operation of the vehicle;

FIG. 4 is a flowchart illustrating operation of a vehicle according to a first modified example; and

FIG. 5 is a flowchart illustrating operation of a vehicle according to a second modified example.

### DETAILED DESCRIPTION

An embodiment of the present disclosure will be described below with reference to the drawings.

In each of the drawings, the same reference numerals are assigned to the same or corresponding portions. In description of the present embodiment, description of the same or corresponding portions will be omitted or simplified as appropriate.

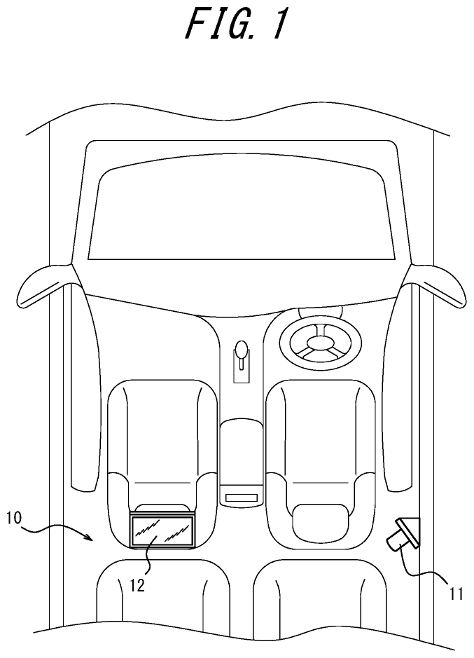

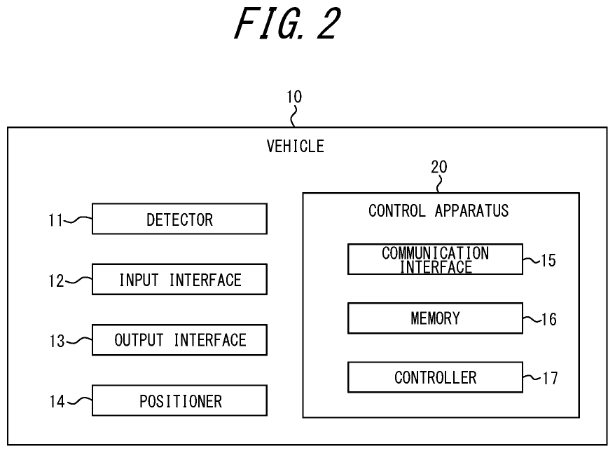

An outline of the present embodiment will be described with reference to FIG. 1 and FIG. 2.

Vehicle 10 is a vehicle which a user can board, such as, for example, an on-demand bus, a hired car, a shared car or a taxi. The vehicle 10 may be driven by a driver or driving may be automated at any level. The level of automation is, for example, one of the levels from level 1 to level 5 as specified by the SAE (Society of Automotive Engineers).

The vehicle 10 is, for example, a vehicle which boards a user to a backseat and travels according to automated driving. As illustrated in FIG. 1, the vehicle 10 includes a detector 11, which acquires an image of the backseat as information indicating a dirt level of the vehicle 10, at a position at which an image of the backseat can be captured, and includes an input interface 12, which acquires input information from a user as information indicating a dirt level of the vehicle 10, at a position at which the user who boards to the backseat can perform an operation.

For example, a case will be assumed in which the user of the vehicle 10 spills a drink on the backseat while the user is on the vehicle 10. The controller 17 acquires an image of the backseat using the detector 11 of the vehicle 10. Alternatively, the controller 17 acquires information indicating that the drink has been spilled on the backseat, input by the user who is on the vehicle 10 through the input interface 12. The vehicle 10 determines whether it is necessary to clean the vehicle 10 based on this information.

The vehicle 10 may determine that the backseat of the vehicle 10 is not dirty and it is not necessary to clean the vehicle 10 based on the image acquired by the detector 11 and the information input to the input interface 12. As a result, the vehicle 10 can, for example, continue traveling to allow the next user to board the vehicle 10.

Conversely, the controller 17 may determine that the backseat of the vehicle 10 is dirty and it is necessary to clean the vehicle 10, based on the image acquired by the detector 11 and the information input to the input interface 12. As a result, the vehicle 10 can, for example, generate a travel plan to a location where cleaning of the vehicle 10 is to be performed, and can travel by automated driving. In this manner, the controller 17 can determine whether it is necessary to clean the vehicle 10, based on information indicating a dirt level of the vehicle 10. In this manner, the usability of techniques for determining a dirt level of the vehicle 10 are improved.

A configuration of the vehicle 10 according to the present embodiment will be described with reference to FIG. 2.

The vehicle 10 includes the detector 11, the input interface 12, an output interface 13, a positioner 14, a communication interface 15, a memory 16, and a controller 17. The detector 11, the input interface 12, the output interface 13, the positioner 14, the communication interface 15, the memory 16 and the controller 17 are connected so as to be able to perform communication with each other via, for example, an in-vehicle network such as a CAN (Controller Area Network) or a leased line.

The control apparatus 20 provided in the vehicle 10 may include at least one of the detector 11, the input interface 12, the output interface 13, the positioner 14, the communication interface 15, the memory 16 and the controller 17. The control apparatus 20 is an apparatus which controls at least some of the mechanisms provided in the vehicle 10. The control apparatus 20 may be, for example, an ECU (Electronic Control Unit) mounted in the vehicle 10. However, the control apparatus 20 is not limited to the ECU, and may be an arbitrary in-vehicle apparatus such as a car navigation apparatus. For example, FIG. 2 illustrates an example in which the control apparatus 20 includes the communication interface 15, the memory 16 and the controller 17.

The detector 11 includes one or more sensors. The sensor is, for example, an image sensor, a sound sensor, an odor sensor, a moisture sensor, or the like. The detector 11 acquires physical or chemical information for the interior or the exterior of the vehicle 10. For example, an in-vehicle camera provided in the interior or on the exterior of the vehicle may function as the detector 11.

The input interface 12 accepts an input operation from a user of the vehicle 10. The input interface 12 includes an input apparatus such as, for example, a button, a touch panel, a camera, a microphone, and/or an IC card reader.

The output interface 13 outputs information using images, sounds, or the like. The output interface 13 includes an output apparatus such as, for example, a display and/or a speaker.

The positioner 14 measures a position of the vehicle 10 and generates position information. In the present disclosure, the position information includes a coordinate such as a two-dimensional coordinate and a three-dimensional coordinate. The positioner 14 includes a receiver which supports a satellite positioning system. The satellite positioning system supported by the receiver may be, for example, GPS (Global Positioning System). Alternatively, the positioner 14 may include an acceleration sensor, a gyro sensor, or the like. For example, a car navigation apparatus may function as the positioner 14.

The communication interface 15 includes one or more communication modules. The communication module is, for example, a communication module which supports mobile communication standards such as, for example, the 4G (4th Generation) and 5G (5th Generation) standards. The communication module may be a communication module which supports near field wireless communication standards such as Wi-Fi® (Wi-Fi is a registered trademark in Japan, other countries, or both), Bluetooth® (Bluetooth is a registered trademark in Japan, other countries, or both) and infrared communication. The communication module may be a communication module which supports communication standards for an in-vehicle network such as a CAN as described above. For example, in-vehicle communication equipment may function as the communication interface 15.

The memory 16 is, for example, a semiconductor memory, a magnetic memory, an optical memory, or the like. The memory 16 functions as, for example, a main storage apparatus, an auxiliary storage apparatus or a cache memory. The memory 16 stores arbitrary information to be used for operation of respective functions of the vehicle 10 and the control apparatus 20. For example, the memory 16 stores a system program, an application program, built-in software, or the like.

The memory 16, for example, stores information on users who board the vehicle 10. The memory 16 may store user identification information which uniquely identifies the users. The user identification information will be also referred to as a user ID (Identifier). For example, when the user is boarding or alighting the vehicle 10, the information on the users who board the vehicle 10 may be updated by IC cards of the users which are passed over an IC card reader included in the input interface 12.

The controller 17 includes one or more processors. The processor may be, for example, a general-purpose processor such as a CPU (Central Processing Unit), a dedicated processor which is dedicated to particular processing, or the like. The controller 17 may include one or more dedicated circuits as well as processors. The dedicated circuit may be, for example, an FPGA (Field-Programmable Gate Array), or an ASIC (Application Specific Integrated Circuit). The controller 17 respectively controls the detector 11, the input interface 12, the output interface 13, the positioner 14, the communication interface 15, and the memory 16 described above to realize functions thereof.

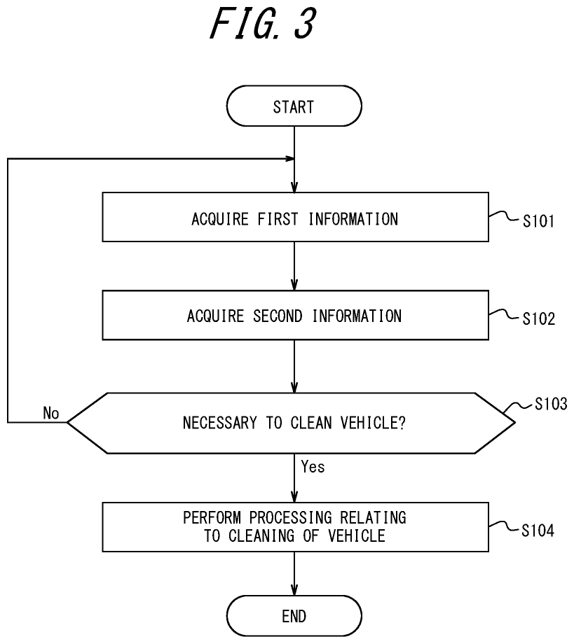

Operation of the vehicle 10 to be realized by each function of the vehicle 10 under the control of the controller 17 will be described with reference to FIG. 3. Operation of the vehicle 10 corresponds to a control method for the vehicle 10 and a control method for the control apparatus 20 of the vehicle 10.

In step S101, the controller 17 acquires first information indicating a dirt level of the vehicle 10 detected by the vehicle 10.

Specifically, the controller 17 captures an image of the interior or the exterior of the vehicle 10 using an image sensor included in the detector 11 and acquires the captured image as the first information. The controller 17 may acquire an interior sound of the vehicle 10 as the first information using a sound sensor included in the detector 11. The controller 17 may acquire an interior odor of the vehicle 10 as the first information using an odor sensor included in the detector 11. Alternatively, the controller 17 may acquire an amount of moisture included in a seat, or the like, provided in the interior of the vehicle 10 as the first information using a moisture sensor included in the detector 11. The controller 17 may cause the acquired first information to be stored in the memory 16.

In step S102, the controller 17 acquires second information indicating a dirt level of the vehicle 10 input by the user of the vehicle 10.

Specifically, in a case in which a button included in the input interface 12 is depressed by the user of the vehicle 10, the controller 17 acquires information indicating that the button has been depressed by the user as the second information. The controller 17 may acquire information input by the user as the second information in a case in which a touch panel included in the input interface 12 is operated by the user of the vehicle 10. The controller 17 may cause the acquired second information to be stored in the memory 16 in association with the above-described user ID.

In step S103, the controller 17 determines whether it is necessary to clean the vehicle 10, based on at least one of the first information indicating the dirt level of the vehicle 10 detected by the vehicle 10 and the second information indicating the dirt level of the vehicle 10 input by the user of the vehicle 10.

Specifically, the controller 17 determines whether it is necessary to clean the vehicle 10, based on the first information. In the present embodiment, description will be provided assuming that the necessity of cleaning the vehicle 10 is expressed with two levels: a level indicating that it is necessary to clean the vehicle 10 and a level indicating that it is not necessary to clean the vehicle 10. However, the necessity of cleaning the vehicle 10 may be expressed with three or more levels in accordance with a dirt level, necessary cleaning content, or the like. For example, the controller 17 may determine whether it is necessary to clean the vehicle 10 in accordance with whether the first information satisfies a first condition. The first condition may be a dirt level indicated by the first information exceeding a predetermined threshold. Specifically, in a case in which the image of the vehicle 10 is acquired as the first information, the controller 17 compares the acquired image included in the first information with an image captured before use, which has been stored in advance in the memory 16. For example, the controller 17 uses an image recognition technique such as color recognition to determine that the first information satisfies the first condition in a case in which an area of a portion where there is a difference in color between the image included in the first information and the image captured before use exceeds a predetermined threshold. The controller 17 may determine that the first information satisfies the first condition in a case in which a sound volume, odor or an amount of moisture included in the first information exceeds a predetermined threshold. The controller 17 may determine that the first information satisfies the first condition in a case in which the sound volume of the interior of the vehicle 10 included in the first information exceeds predetermined threshold, including the sound volume of a voice which is uttered in a case in which the user of the vehicle 10 spills drink, a sound volume of sound made when a receptacle holding a drink is broken, and the like. The controller 17 may determine that the first information satisfies the first condition in a case in which the odor of the vehicle 10 included in the first information exceeds a predetermined threshold. Alternatively, the controller 17 may determine that the first information satisfies the first condition in a case in which the amount of moisture of the backseat of the vehicle 10 included in the first information exceeds a predetermined threshold.

Further, the controller 17 determines whether it is necessary to clean the vehicle 10 based on the second information. The controller 17 may determine whether it is necessary to clean the vehicle 10 based on whether the second information satisfies a second condition. Specifically, the controller 17 determines that the second information satisfies the second condition in a case in which the second information includes information indicating that a dirt notification button has been depressed. The dirt notification button is a button which is depressed by the user when the user feels that the vehicle 10 is so dirty that it is necessary to clean the vehicle 10. The information indicating that the dirt notification button has been depressed is information input by the user, indicating that the dirt level of the vehicle 10 is such that it is necessary to clean the vehicle 10. While the dirt notification button may be provided at an arbitrary location, in the present embodiment, the dirt notification button is provided in the interior of the vehicle 10, such as on the backseat of the vehicle 10. The controller 17 may determine that the second information satisfies the second condition in a case in which the dirt level of the vehicle 10 indicated by the second information exceeds a predetermined threshold.

As described above, in the present embodiment, the controller 17 determines whether it is necessary to clean the vehicle 10 based on both the first information and the second information. The controller 17 may determine that it is necessary to clean the vehicle 10 in a case in which it is determined that the first information satisfies the first condition and in a case in which it is determined that the second information satisfies the second condition.

In a case in which a determination result as to whether it is necessary to clean the vehicle 10, based on the first information, is different from a determination result as to whether it is necessary to clean the vehicle 10, based on the second information, the controller 17 determines whether it is necessary to clean the vehicle 10 in favor of the determination result based on the first information or the determination result based on the second information in accordance with a predetermined priority.

For example, the controller 17 can determine whether it is necessary to clean the vehicle 10 in favor of the determination result based on the first information or the determination result based on the second information, based on a past usage record of the vehicle 10 by the user. The past usage record of the vehicle 10 by the user includes the number of times, a rate, or the like, of the vehicle 10 being cleaned in association with use by the user. The controller 17 specifies the user of the vehicle 10 using the above-described user ID. For example, it is considered that a user who often dirties the vehicle 10 is insensitive to dirt on the vehicle 10. Therefore, it can be estimated that the second information input by the user is highly likely to be incorrect. In a case in which it is determined from the past usage record of the vehicle 10 by the user that the user is highly likely to dirty the vehicle 10, the controller 17 prioritizes the determination result based on the first information to set the determination result based on the first information as the determination result based on the first information and the second information.

Alternatively, the controller 17 can determine whether it is necessary to clean the vehicle 10 in favor of the determination result based on the first information or the determination result based on the second information, based on history of second information input by the user in the past. For example, the history of the second information input by the user in the past may include the number of times, a rate, or the like, of the second information indicating that the vehicle 10 is dirty being input when the user has used the vehicle 10 in the past. For example, it can be considered that a user who often reports dirt on the vehicle 10 is sensitive to dirt on the vehicle 10. Therefore, it can be estimated that the second information input by the user is highly likely to be incorrect. In a case in which it is determined that the user is a user who depresses the dirt notification button very often from the history of the second information of the vehicle 10 by the user in the past, the controller 17 prioritizes the determination result based on the first information to set the determination result based on the first information as the determination result based on the first information and the second information.

In a case in which it is determined that it is necessary to clean the vehicle 10, based on the first information and the second information (step S103: Yes), the controller 17 executes processing in step S104. Conversely, in a case in which it is determined that it is not necessary to clean the vehicle 10, based on the first information and the second information (step S103: No), the controller 17 repeats processing from step S101.

In step S104, the controller 17 performs processing regarding cleaning of the vehicle 10. The processing regarding cleaning of the vehicle 10 may be cleaning of the vehicle 10 itself, or processing for cleaning of the vehicle 10.

For example, in a case in which it is determined that it is necessary to clean the vehicle 10, the controller 17 may perform control to clean the vehicle 10. Specifically, the controller 17 causes in-vehicle equipment such as a cleaner and an air purifier provided in the vehicle 10 to operate and causes the in-vehicle equipment to clean the interior or the exterior of the vehicle 10.

In a case in which it is determined that it is necessary to clean the vehicle 10, the controller 17 may transmit a request for cleaning of the vehicle 10. Specifically, the controller 17 transmits a request for cleaning the vehicle 10 to an information processing apparatus, or the like, operated by an administrator of the vehicle 10 via the communication interface 15. The request for cleaning of the vehicle 10 includes the position information for the vehicle 10 measured by the positioner 14. In this manner, the administrator of the vehicle 10 can dispatch a cleaning vehicle which carries cleaning staff or cleaning equipment, or the like, for the vehicle 10 to the position information for the vehicle 10.

Alternatively, in a case in which it is determined that it is necessary to clean the vehicle 10, the controller 17 may generate a travel plan to a location where cleaning of the vehicle 10 is to be performed. Specifically, the controller 17 stores position information for a location where cleaning of the vehicle 10 is to be performed, such as a maintenance factory and/or a cleaning station for the vehicle 10 in the memory 16. The controller 17 generates the travel plan for the vehicle 10, based on the position information for the vehicle 10 measured by the positioner 14 and the position information for the location where cleaning of the vehicle 10 is to be performed. The travel plan for the vehicle 10 may include, for example, the position information for the vehicle 10 as a departure place, the position information for the location where cleaning of the vehicle 10 is to be performed as a destination, a travel route from the departure place to the destination, an estimated time of arrival at the destination, or the like. The controller 17 may cause the generated travel plan for the vehicle 10 to be stored in the memory 16. The controller 17 may travel using automated driving or may support driving by a driver, based on the travel plan for the vehicle 10. Alternatively, the controller 17 may cause information included in the travel plan for the vehicle 10 to be displayed on the display of the output interface 13.

In a case in which the necessity of cleaning the vehicle 10 is expressed in three or more levels, the controller 17 may select and perform at least one of control to clean the vehicle 10, transmission of a request for cleaning of the vehicle 10, and generation of a travel plan for the vehicle 10, as described above, in accordance with the levels for the necessity of cleaning the vehicle 10. For example, in a case in which a dirt level of the vehicle 10 is low, the controller 17 may perform control to clean the vehicle 10, while, in a case in which a dirt level of the vehicle 10 is high, the controller 17 may transmit a request for cleaning of the vehicle 10 or generate a travel plan for the vehicle 10.

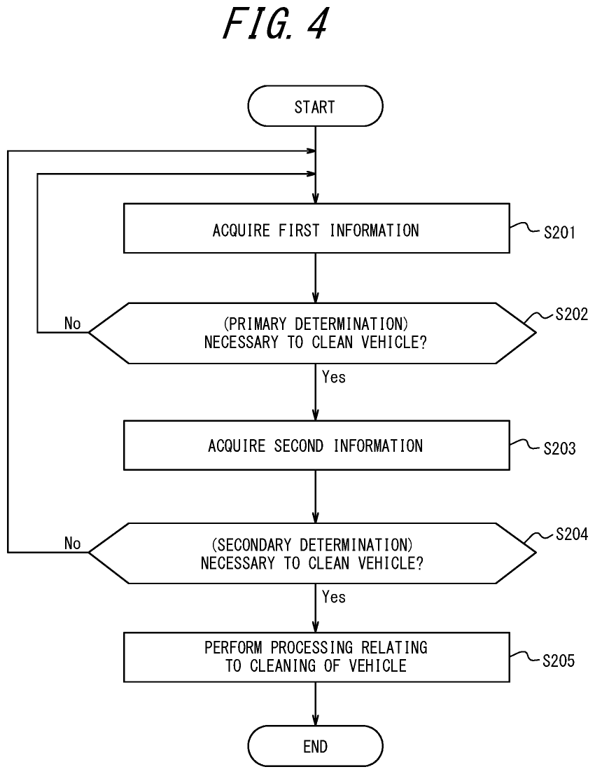

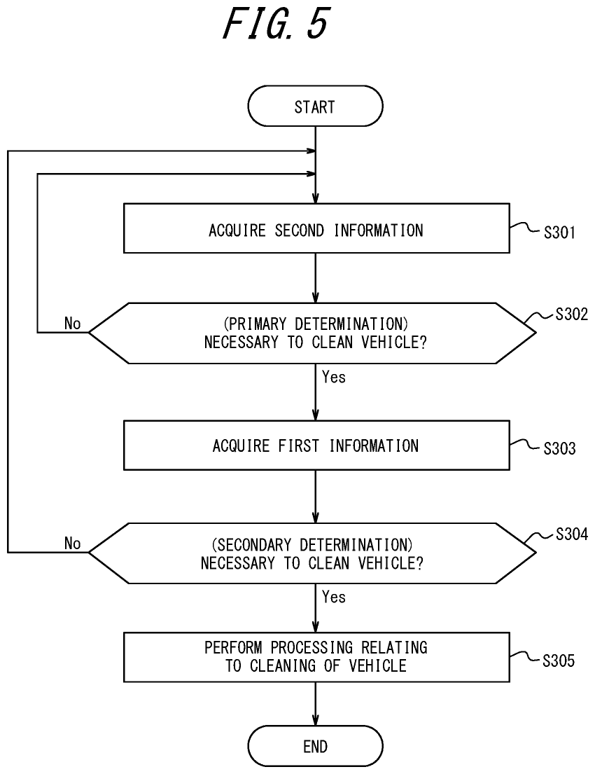

Modified examples of the operation of the vehicle 10 to be realized by each function of the vehicle 10 under the control of the controller 17 will be described next with reference to FIG. 4 and FIG. 5. In the present modified example, the controller 17 performs determination based on the first information and determination based on the second information in a stepwise manner. Operation of the vehicle 10 in the present modified example corresponds to a control method of the vehicle 10 and a control method for the control apparatus 20 of the vehicle 10.

### First Modified Example

As illustrated in FIG. 4, the controller 17 determines whether it is necessary to clean the vehicle 10 by performing a primary determination in which it is determined whether it is necessary to clean the vehicle 10 based on the first information, and, in a case in which it is determined in the primary determination that it is necessary to clean the vehicle 10, performing a secondary information in which it is determined whether it is necessary to clean the vehicle 10 based on the second information. In this manner, the controller 17 can reduce the number of times that the user of the vehicle 10 inputs information via the input interface 12, so that it is possible to reduce the load on the user of the vehicle 10.

In step S201, the controller 17 acquires first information indicating a dirt level of the vehicle 10 detected by the vehicle 10. The present step corresponds to step S101 described above.

In step S202, the controller 17 performs the primary determination in which it is determined whether it is necessary to clean the vehicle 10, based on the first information.

Specifically, as described above in step S103, the controller 17 performs the primary determination in which it is determined whether it is necessary to clean the vehicle 10, based on whether the first information satisfies the first condition. In a case in which the first information satisfies the first condition, the controller 17 determines that it is necessary to clean the vehicle 10. In a case in which it is determined in the primary determination based on the first information that it is necessary to clean the vehicle 10 (step S202: Yes), the controller 17 executes processing in step S203.

Conversely, in a case in which the first information does not satisfy the first condition, the controller 17 determines that it is not necessary to clean the vehicle 10. In a case in which it is determined that it is not necessary to clean the vehicle 10 (step S202: No), the controller 17 repeats processing from step S201.

In step S203, the controller 17 acquires second information indicating a dirt level of the vehicle 10 input by the user of the vehicle 10. The present step corresponds to step S102 described above.

In step S204, the controller 17 performs the secondary determination in which it is determined whether it is necessary to clean the vehicle 10, based on the second information.

Specifically, as described above in step S103, the controller 17 performs the secondary determination in which it is determining whether the second information satisfies the second condition. In a case in which it is determined that the second information satisfies the second condition, the controller 17 determines that it is necessary to clean the vehicle 10. In a case in which it is determined that it is necessary to clean the vehicle 10 (step S204: Yes), the controller 17 executes processing in step S205.

Conversely, in a case in which it is determined that the second information does not satisfy the second condition, the controller 17 determines that it is not necessary to clean the vehicle 10. In a case in which it is determined that it is not necessary to clean the vehicle 10 (step S204: No), the controller 17 repeats processing from step S201.

In step S205, the controller 17 performs processing regarding cleaning of the vehicle 10. The present step corresponds to step S104 described above.

### Second Modified Example

As illustrated in FIG. 5, the controller 17 determines whether it is necessary to clean the vehicle 10 by performing the primary determination in which it is determined whether it is necessary to clean the vehicle 10 based on the second information, and, in a case in which it is determined in the primary determination that it is necessary to clean the vehicle 10, performing the secondary determination in which it is determined whether it is necessary to clean the vehicle 10, based on the first information. In this manner, by virtue of the first information being acquired by the detector 11 only in a case in which it is determined in the primary determination based on the second information that it is necessary to clean the vehicle, the controller 17 can reduce power consumption resulting from operation of the detector 11.

In step S301, the controller 17 acquires the second information indicating a dirt level of the vehicle 10 input by the user of the vehicle 10.

The present step corresponds to step S102 described above.

In step S302, the controller 17 performs the primary determination in which it is determined whether it is necessary to clean the vehicle 10 based on the second information.

Specifically, as described above in step S103, the controller 17 performs the primary determination in which it is determined whether it is necessary to clean the vehicle 10 based on whether the second information acquired via the input interface 12 satisfies the second condition. In a case in which the second information satisfies the second condition, the controller 17 determines that it is necessary to clean the vehicle 10. In a case in which it is determined in the primary determination based on the second information that it is necessary to clean the vehicle 10 (step S302: Yes), the controller 17 executes processing in step S303.

Conversely, in a case in which the second information does not satisfy the second condition, the controller 17 determines that it is not necessary to clean the vehicle 10. In a case in which it is determined that it is not necessary to clean the vehicle 10 (step S302: No), the controller 17 repeats processing from step S301.

In step S303, the controller 17 acquires first information indicating a dirt level of the vehicle 10 detected by the vehicle 10. The present step corresponds to step S101 described above.

In step S304, the controller 17 performs the secondary determination in which it is determined whether it is necessary to clean the vehicle 10, based on the first information.

Specifically, as described above in step S103, the controller 17 performs the secondary determination in which it is determined whether the first information acquired via the detector 11 satisfies the first condition. In a case in which it is determined that the first information satisfies the first condition, the controller 17 determines that it is necessary to clean the vehicle 10. In a case in which it is determined that it is necessary to clean the vehicle 10 (step S304: Yes), the controller 17 executes processing in step S305.

Conversely, in a case in which it is determined that the first information acquired via the detector 11 does not satisfy the first condition, the controller 17 determines that it is not necessary to clean the vehicle 10. In a case in which it is determined that it is not necessary to clean the vehicle 10 (step S304: No), the controller 17 repeats processing from step S301.

In step S305, the controller 17 performs processing regarding cleaning of the vehicle 10. The present step corresponds to step S104 described above.

As described above, the control apparatus 20 according to the present embodiment is the control apparatus 20 of the vehicle 10. The control apparatus 20 includes the controller 17. The controller 17 determines whether it is necessary to clean the vehicle 10, based on at least one of first information indicating a dirt level of the vehicle 10 detected by the vehicle 10, and second information indicating a dirt level of the vehicle 10 input by the user of the vehicle 10. According to such a configuration, the control apparatus 20 of the vehicle 10 can determine whether it is necessary to clean the vehicle 10, based on information indicating a dirt level of the vehicle 10 in at least one of the first information detected by the vehicle 10 and the second information input by the user. Therefore, the usability of techniques for determining a dirt level of the vehicle 10 are improved.

In the control apparatus 20 of the vehicle 10 according to the present embodiment, the first information may include an image captured by an image sensor. According to such a configuration, the control apparatus 20 of the vehicle 10 can determine a dirt level of the vehicle 10 and determine whether it is necessary to clean the vehicle 10, based on the image.

In the control apparatus 20 of the vehicle 10 according to the present embodiment, the controller 17 can determine whether it is necessary to clean the vehicle 10, based on both the first information and the second information. According to such a configuration, the control apparatus 20 of the vehicle 10 can improve the accuracy of the determination as to whether it is necessary to clean the vehicle 10.

In the control apparatus 20 of the vehicle 10 according to the present embodiment, in a case in which a determination result based on the first information is different from a determination result based on the second information, the controller 17 can determine whether it is necessary to clean the vehicle 10 in favor of the determination result based on the first information or the determination result based on the second information, based on a past usage record of the vehicle 10 by the user. According to such a configuration, in a case in which the determination result based on the first information is different from the determination result based on the second information, the control apparatus 20 of the vehicle 10 can determine whether it is necessary to clean the vehicle 10 upon evaluating a likelihood that the user will dirty the vehicle 10, based on the past usage record of the vehicle 10 by the user. In this manner, the control apparatus 20 can improve the accuracy of the determination as to whether it is necessary to clean the vehicle 10.

In the control apparatus 20 of the vehicle 10 according to the present embodiment, in a case in which the determination result based on the first information is different from the determination result based on the second information, the controller 17 can determine whether it is necessary to clean the vehicle 10 in favor of the determination result based on the first information or the determination result based on the second information, based on a history of second information input by the user in the past. According to such a configuration, in a case in which the determination result based on the first information is different from the determination result based on the second information, the control apparatus 20 of the vehicle 10 can determine whether it is necessary to clean the vehicle 10 upon accounting for the tendency of the user to input second information, based on the history of second information for the vehicle 10 by the user in the past. In this manner, the control apparatus 20 can improve the accuracy of the determination as to whether it is necessary to clean the vehicle 10.

In the control apparatus 20 of the vehicle 10 according to the present embodiment, in a case in which it is determined that it is necessary to clean the vehicle 10, the controller 17 can perform control to clean the vehicle 10. According to such a configuration, in a case in which it is determined that it is necessary to clean the vehicle 10, the control apparatus 20 of the vehicle 10 can realize cleaning of the vehicle 10.

In the control apparatus 20 of the vehicle 10 according to the present embodiment, in a case in which it is determined that it is necessary to clean the vehicle 10, the controller 17 can transmit a request for cleaning of the vehicle 10. According to such a configuration, in a case in which it is determined that it is necessary to clean the vehicle 10, the control apparatus 20 of the vehicle 10 can realize cleaning of the vehicle 10.

In the control apparatus 20 of the vehicle 10 according to the present embodiment, in a case in which it is determined that it is necessary to clean the vehicle 10, the controller 17 can generate a travel plan to a location where cleaning of the vehicle 10 is to be performed. According to such a configuration, in a case in which it is determined that it is necessary to clean the vehicle 10, the control apparatus 20 of the vehicle 10 can realize cleaning of the vehicle 10.

In the control apparatus 20 of the vehicle 10 according to the present embodiment, the controller 17 can determine whether it is necessary to clean the vehicle 10 by performing the primary determination in which it is determined whether it is necessary to clean the vehicle 10, based on the first information, and, in a case in which it is determined in the primary determination that it is necessary to clean the vehicle 10, perform the secondary determination in which it is determined whether it is necessary to clean the vehicle 10, based on the second information. According to such a configuration, the control apparatus 20 of the vehicle 10 can reduce the number of times that the user of the vehicle 10 inputs information via the input interface 12, so that it is possible to reduce load of the user of the vehicle 10.

In the control apparatus 20 of the vehicle 10 according to the present embodiment, the controller 17 can determine whether it is necessary to clean the vehicle 10 by performing the primary determination in which it is determined whether it is necessary to clean the vehicle 10, based on the second information, and, in a case in which it is determined in the primary determination that it is necessary to clean the vehicle 10, performing the secondary determination in which it is determined whether it is necessary to clean the vehicle 10, based on the first information. According to such a configuration, by the first information being acquired by the detector 11 only in a case in which it is judged in the primary determination based on the second information that it is necessary to clean the vehicle 10, the control apparatus 20 of the vehicle 10 can reduce the power consumption resulting from operation of the detector 11.

The vehicle 10 according to the present embodiment includes the control apparatus 20 described above. According to such a configuration, the vehicle 10 can determine whether it is necessary to clean the vehicle 10, based on information indicating a dirt level of the vehicle 10 in at least the first information detected by the vehicle 10 and the second information input by the user. Therefore, the usability of techniques for determining a dirt level of the vehicle 10 are improved.

The control method according to the present embodiment is a control method for the vehicle 10. In the control method, the controller 17 determines whether it is necessary to clean the vehicle 10, based on at least one of first information indicating a dirt level of the vehicle 10 detected by the vehicle 10 and second information indicating a dirt level of the vehicle 10 input by the user of the vehicle 10. According to such a configuration, the vehicle 10 can determine whether it is necessary to clean the vehicle 10, based on information indicating a dirt level of the vehicle 10 in at least one of the first information detected by the vehicle 10 and the second information input by the user. Therefore, the usability of techniques for determining a dirt level of the vehicle 10 are improved.

In the control method according to the present embodiment, the controller 17 can determine whether it is necessary to clean the vehicle 10, based on both the first information and the second information. According to such a configuration, the control apparatus 20 of the vehicle 10 can improve the accuracy of the determination as to whether it is necessary to clean the vehicle 10.

In the control method according to the present embodiment, in a case in which the determination result based on the first information is different from the determination result based on the second information, the controller 17 can determine whether it is necessary to clean the vehicle 10 in favor of the determination result based on the first information or the determination result based on the second information, based on a past usage record of the vehicle 10 by the user. According to such a configuration, in a case in which the determination result based on the first information is different from the determination result based on the second information, the control apparatus 20 of the vehicle 10 can determine whether it is necessary to clean the vehicle 10 upon evaluating the likelihood that the user will dirty the vehicle 10, based on the past usage record of the vehicle 10 by the user. In this manner, the control apparatus 20 can improve the accuracy of the determination as to whether it is necessary to clean the vehicle 10.

In the control method according to the present embodiment, in a case in which the determination result based on the first information is different from the determination result based on the second information, the controller 17 can determine whether it is necessary to clean the vehicle 10 in favor of the determination result based on the first information or the determination result based on the second information, based on a history of second information input by the user in the past. According to such a configuration, in a case in which the determination result based on the first information is different from the determination result based on the second information, the control apparatus 20 of the vehicle 10 can determine whether it is necessary to clean the vehicle 10 upon accounting for the tendency of the user to input the second information, based on the history of second information for the vehicle 10 by the user in the past. In this manner, the control apparatus 20 can improve the accuracy of the determination as to whether it is necessary to clean the vehicle 10.

In the control method according to the present embodiment, in a case in which it is determined that it is necessary to clean the vehicle 10, the controller 17 can perform control to clean the vehicle 10. According to such a configuration, in a case in which it is determined that it is necessary to clean the vehicle 10, the control apparatus 20 of the vehicle 10 can realize cleaning of the vehicle 10.

In the control method according to the present embodiment, in a case in which it is determined that it is necessary to clean the vehicle 10, the controller 17 can transmit a request for cleaning of the vehicle 10. According to such a configuration, in a case in which it is determined that it is necessary to clean the vehicle 10, the control apparatus 20 of the vehicle 10 can realize cleaning of the vehicle 10.

In the control method according to the present embodiment, in a case in which it is determined that it is necessary to clean the vehicle 10, the controller 17 can generate a travel plan to a location where cleaning of the vehicle 10 is to be performed. According to such a configuration, in a case in which it is determined that it is necessary to clean the vehicle 10, the control apparatus 20 of the vehicle 10 can realize cleaning of the vehicle 10.

In the control method according to the present embodiment, the controller 17 can determine whether it is necessary to clean the vehicle 10 by performing the primary determination in which it is determined whether it is necessary to clean the vehicle 10, based on the first information, and, in a case in which it is determined in the primary determination that it is necessary to clean the vehicle 10, performing the secondary determination in which it is determined whether it is necessary to clean the vehicle 10, based on the second information. According to such a configuration, the control apparatus 20 of the vehicle 10 can reduce the number of times that the user of the vehicle 10 inputs information via the input interface 12, so that it is possible to reduce load of the user of the vehicle 10.

In the control method according to the present embodiment, the controller 17 can determine whether it is necessary to clean the vehicle 10 by performing the primary determination in which it is determined whether it is necessary to clean the vehicle 10, based on the second information, and, in a case in which it is determined in the primary determination that it is necessary to clean the vehicle 10, performing the secondary determination in which it is determined whether it is necessary to clean the vehicle 10, based on the first information. According to such a configuration, by the first information being acquired by the detector 11 only in a case in which it is judged in the primary determination based on the second information that it is necessary to clean the vehicle 10, the control apparatus 20 of the vehicle 10 can reduce the power consumption resulting from operating the detector 11.

While the present disclosure has been described based on the drawings and examples, it is to be noted that a person skilled in the art can easily make various modifications and revisions based on the present disclosure. It is to be, therefore, noted that these modifications and revisions are included in the scope of the present disclosure. For example, it is possible to rearrange functions, or the like, included in the respective means, the respective steps, or the like, without producing logical inconsistency, and it is possible to combine a plurality of means, steps, or the like, to make one means, step, or the like, or divide the means, steps, or the like.

For example, in the above-described embodiment, all or some of functions or processing described as the functions or the processing of the vehicle 10 or the control apparatus 20 may be realized as functions or processing of a general-purpose information processing apparatus such as, for example, a smartphone and a computer. Specifically, it is also possible to store a program which describes processing content for realizing respective functions of the vehicle 10 or the control apparatus 20 according to the embodiment in a memory of an information processing apparatus and cause a processor of the information processing apparatus to read out and execute the program. Therefore, the aspects according to the present embodiment can be realized as a program which can be executed by a processor. For example, in a case in which a general-purpose information processing apparatus is caused to function as the control apparatus 20 of the vehicle 10, the aspects according to the present embodiment can be realized by providing an information processing apparatus having the above-described configuration and functions as the configuration and the functions of the control apparatus 20 of the vehicle 10, in the vehicle 10.

1. A control apparatus for a vehicle, comprising:
a controller configured to determine whether it is necessary to clean the vehicle based on at least one of first information indicating a dirt level of the vehicle detected by the vehicle, and second information indicating a dirt level of the vehicle input by a user of the vehicle.

2. The control apparatus according to claim 1,
wherein the first information includes an image captured by an image sensor.

3. The control apparatus according to claim 1,
wherein the controller determines whether it is necessary to clean the vehicle based on both the first information and the second information.

4. The control apparatus according to claim 3,
wherein, in a case in which a determination result based on the first information is different from a determination result based on the second information, the controller determines whether it is necessary to clean the vehicle in favor of the determination result based on the first information or the determination result based on the second information, based on a past usage record of the vehicle by the user.

5. The control apparatus according to claim 3,
wherein, in a case in which a determination result based on the first information is different from a determination result based on the second information, the controller determines whether it is necessary to clean the vehicle in favor of the determination result based on the first information or the determination result based on the second information, based on a history of second information input by the user in the past.

6. The control apparatus according to claim 1,
wherein, in a case in which it is determined that it is necessary to clean the vehicle, the controller performs control to clean the vehicle.

7. The control apparatus according to claim 1,
wherein, in a case in which it is determined that it is necessary to clean the vehicle, the controller transmits a request for cleaning of the vehicle.

8. The control apparatus according to claim 1,
wherein, in a case in which it is determined that it is necessary to clean the vehicle, the controller generates a travel plan to a location where cleaning of the vehicle is to be performed.

9. The control apparatus according to claim 1,
wherein the controller determines whether it is necessary to clean the vehicle by performing a primary determination in which it is determined whether it is necessary to clean the vehicle based on the first information, and, in a case in which it is determined in the primary determination that it is necessary to clean the vehicle, performing a secondary determination in which it is determined whether it is necessary to clean the vehicle based on the second information.

10. The control apparatus according to claim 1,
wherein the controller determines whether it is necessary to clean the vehicle by performing a primary determination in which it is determined whether it is necessary to clean the vehicle based on the second information, and, in a case in which it is determined in the primary determination that it is necessary to clean the vehicle, performing a secondary determination in which it is determined whether it is necessary to clean the vehicle based on the first information.

11. A vehicle comprising the control apparatus according to claim 1.

12. A control method of a vehicle, comprising:
a controller determining whether it is necessary to clean the vehicle based on at least one of first information indicating a dirt level of the vehicle detected by the vehicle, and second information indicating a dirt level of the vehicle input by a user of the vehicle.

13. The control method according to claim 12,
wherein the controller determines whether it is necessary to clean the vehicle based on both the first information and the second information.

14. The control method according to claim 13,
wherein, in a case in which a determination result based on the first information is different from a determination result based on the second information, the controller determines whether it is necessary to clean the vehicle in favor of the determination result based on the first information or the determination result based on the second information based on a past usage record of the vehicle by the user.

15. The control method according to claim 13,
wherein, in a case in which a determination result based on the first information is different from a determination result based on the second information, the controller determines whether it is necessary to clean the vehicle in favor of the determination result based on the first information or the determination result based on the second information based on a history of second information input by the user in the past.

16. The control method according to claim 12,
wherein, in a case in which it is determined that it is necessary to clean the vehicle, the controller performs control to clean the vehicle.

17. The control method according to claim 12,
wherein, in a case in which it is determined that it is necessary to clean the vehicle, the controller transmits a request for cleaning of the vehicle.

18. The control method according to claim 12,
wherein, in a case in which it is determined that it is necessary to clean the vehicle, the controller generates a travel plan to a location where cleaning of the vehicle is to be performed.

19. The control method according to claim 12,
wherein the controller determines whether it is necessary to clean the vehicle by performing a primary determination in which it is determined whether it is necessary to clean the vehicle based on the first information, and, in a case in which it is determined in the primary determination that it is necessary to clean the vehicle, performing a secondary determination in which it is determined whether it is necessary to clean the vehicle based on the second information.

20. The control method according to claim 12,
wherein the controller determines whether it is necessary to clean the vehicle by performing a primary determination in which it is determined whether it is necessary to clean the vehicle based on the second information, and, in a case in which it is determined in the primary determination that it is necessary to clean the vehicle, performing a secondary determination in which it is determined whether it is necessary to clean the vehicle based on the first information.
